(19) United States
(12) Patent Application Publication
(10) Pub. No.: US 2004/0193490 A1
(43) Pub. Date: Sep. 30, 2004

(54) Games involving scratch-off cards to promote business

(75) Inventor: Kenneth P. Pletz, Las Vegas, NV (US)

Correspondence Address: FITCH EVEN TABIN AND FLANNERY, 120 SOUTH LA SALLE STREET, SUITE 1600, CHICAGO, IL, 60603-3406, US

(73) Assignee: PRO MARKETING SYSTEMS, INC. A NEVADA CORPORATION, LAS VEGAS, NV

(21) Appl. No.: 10/780,732

(22) Filed: Feb. 19, 2004

Related U.S. Application Data
(60) Provisional application No. 60/448,475, filed on Feb. 21, 2003.

(51) Int. Cl. G06F 17/60

(52) U.S. Cl. 705/14; 705/1

(57) ABSTRACT

A promotional card for use in a marketing promotion and the method of use thereof. The promotional card has a plurality of scratch-off figures. In one embodiment, each scratch-off figure covers an indication of a prize which can be monetary or non-monetary. A plurality of promotional cards are manufactured by a promoter on behalf of one or more merchants and distributed to one or more agents. The agents, in turn, distribute the promotional cards to a plurality of potential customers. In one embodiment, each customer can only use one promotional card. The customers, when purchasing or leasing a predetermined product or service at one of the participating merchants, redeems the promotional card by presenting the card to the merchant, scratching off one of the figures to reveal an indication of a prize, and receiving the revealed prize from the merchant as part of the purchase or lease transaction. In one embodiment, the promotional cards contain indications of monetary prizes under the scratch-off material, are useable during the purchase of cars or trucks at a participating merchant, and result in the customer receiving a monetary prize as a cash discount at the purchase or lease of a car or truck. After the purchase by the customer, the promoter provides a benefit to the agent for placing the card with the customer.

### FIELD OF THE INVENTION

The present invention relates to gaming devices. More particularly, the present invention relates to promotional gaming devices used in marketing.

### BACKGROUND OF THE INVENTION

Successfully promoting a business or increasing the sales and leases of products or services can benefit from one or more of the following: increasing exposure of the business and its offerings to potential customers, enticing customers to more seriously consider the business and its offerings, and encouraging customers to consider larger investments in the business and its offerings. Traditional methods of reaching these goals include advertisements, sale promotions, coupons, match any competitor's price promotions, word-of-mouth, customer referrals, and so forth. One of the most common methods of promoting businesses is mass mailing. Because most of these mailings are blind, a positive response rate of as little as 2 to 3% is considered successful. Due to the low rate of successful response to such promotional campaigns as mass marketing and coupons, these methods are inefficient and wasteful of promotional resources.

### SUMMARY OF THE INVENTION

The invention relates to a system, method, and apparatus for increasing or promoting product or service sales and leasing that benefit from the natural tendency of people to enjoy games of lottery and chance. The present invention is characterized by the following. A promotional card is used having a plurality of scratch-off figures. Each scratch-off figure hides an indication of a prize. A promoter distributes a plurality of promotional cards through one or more agents to a plurality of potential customers, each customer receiving one card. The customers, when purchasing or leasing a predetermined product or service at a participating merchant, redeem the promotional card by presenting the card to the merchant, scratching off one of the figures to reveal an indication of a prize, and receiving the revealed prize from the merchant as part of the purchase or lease transaction. The customer notifies the agent of the redeemed card and the benefit received, and the agent provides the same information, along with the identity of the customer, to the promoter. The promoter then verifies redemption of the card with the merchant and provides the agent who distributed the redeemed card with a benefit. Because an agent benefits in proportion to the number of cards distributed that ultimately are redeemed, the agent is motivated to distribute promotional cards to potential customers most likely to make use of a participating merchant's business.

The prize indication hidden under each scratch-off figure can be monetary or non-monetary. In one embodiment, three levels of prize indications are hidden under the scratch-off figures. In other embodiments, a lesser or greater variety of prize indications can be hidden under the scratch-off figures as desired. Generally, each customer can only redeem one promotional card per purchase or lease; however, other embodiments allowing a customer to redeem two or more promotional cards or allowing the customer to scratch-off more than one scratch-off figure can be used as desired.

In another embodiment, multiple merchants can participate in a promotion using the same promotional card.

In one embodiment, the benefit provided to agents for having distributed a redeemed card is equal to the benefit received by the customer. In other embodiments, the benefit received by the agent for distributing a redeemed card can be a fixed benefit; or a prorated amount of the benefit received by the customer, and so forth. Additionally, in one embodiment, charitable organizations are used as agents.

### BRIEF DESCRIPTION OF THE DRAWINGS

FIG. 1 is a block diagram showing the interaction between selected participants in a promotion according to one embodiment of the invention;

FIG. 2A shows a front view of a promotional card according to one embodiment of the invention;

FIG. 2B shows a back view of the promotional card of FIG. 2A

FIG. 2C shows an enlarged view of an array of selected scratch-off figures of the promotional card of FIG. 2A;

FIG. 3A shows a front view of a promotional card according to another embodiment of the invention;

FIG. 3B shows a back view of the promotional card of FIG. 3A;

FIG. 4A shows a front view of a promotional card according to a further embodiment of the invention;

FIG. 4B shows a back view of the promotional card of FIG. 4A;

FIG. 5 shows a flowchart for a method of customer participation according to one embodiment of the invention;

FIG. 6 shows a flowchart for a method of agent participation according to one embodiment of the invention;

FIG. 7 shows a flowchart for a method of promoter participation according to one embodiment of the invention; and

FIG. 8 shows a flowchart for a method of merchant participation according to one embodiment of the present invention.

### DETAILED DESCRIPTION

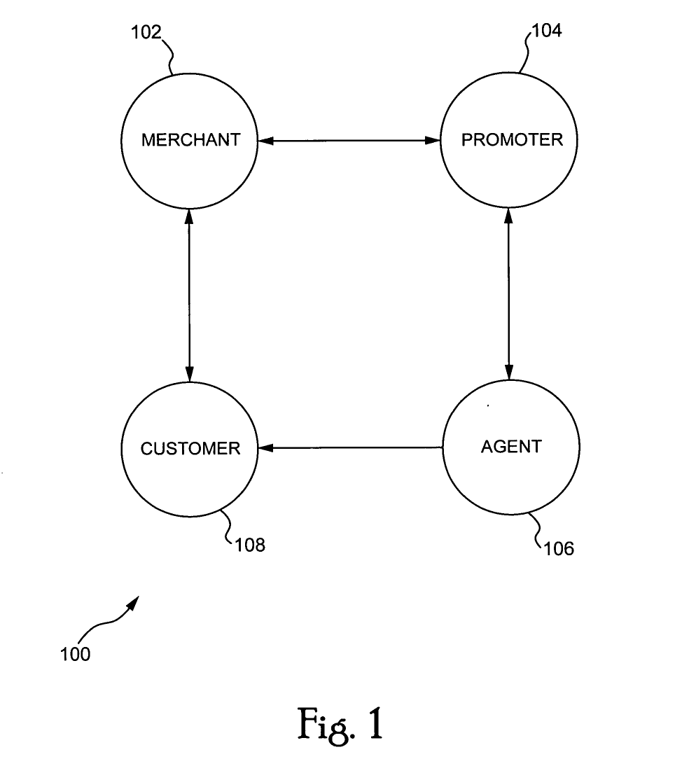

FIG. 1 is a block diagram 100 showing the interaction between selected participants in a promotion according to one embodiment of the invention. The participants are a merchant 102, a promoter 104, an agent 106, and a customer 108. Merchant 102 is typically a business owner, merchant, or dealer offering products and/or services to customers. Promoter 104 is a party who undertakes to promote one or more products or services on behalf of one or more merchants 102. Each agent 106 performs distribution of promotional cards for a promoter 104, and each customer 108 generally receives only one promotional card. Each customer can redeem his or her promotional card with a merchant.

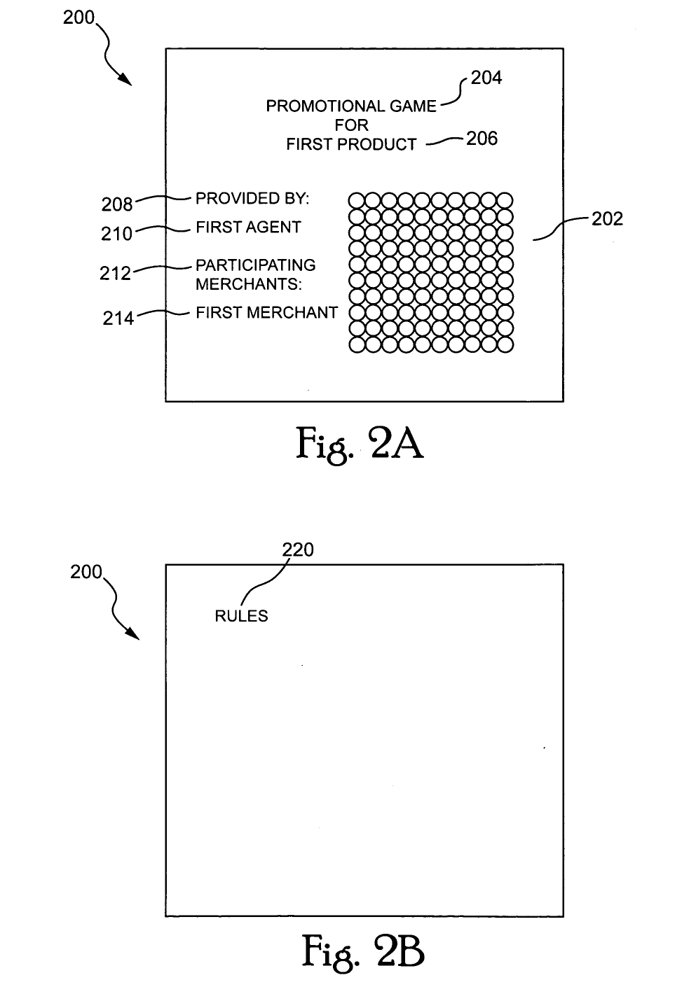

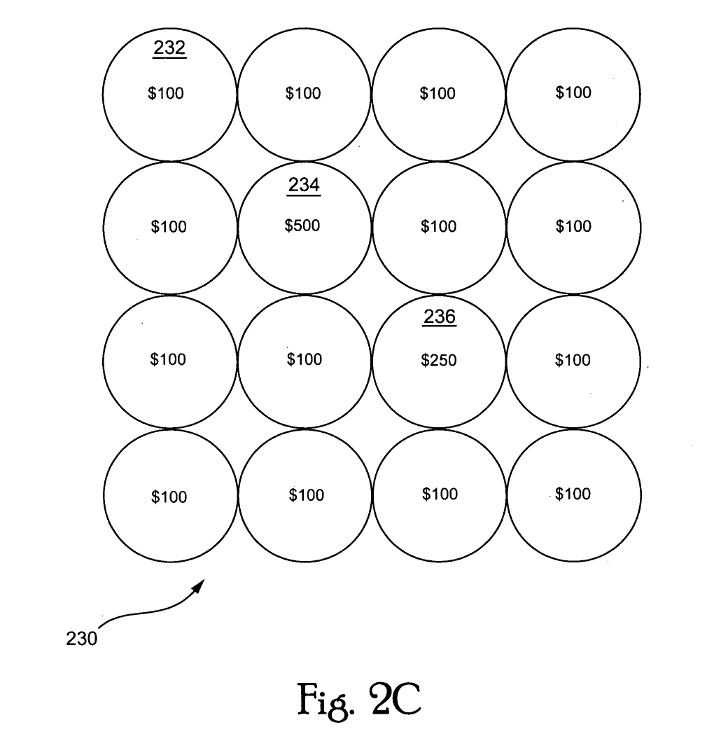

Several embodiments of promotional cards are described in greater detail with reference to FIGS. 2A-2C, 3A-3B and 4A-4B later herein. For the purposes of this discussion, however, in one embodiment the promotional cards provide multiple scratch-off figures, each of which covers an indication of a cash prize.

While one merchant 102, one promoter 104, one agent 106, and one customer 108 are shown, generally one promoter represents two or more merchants, and uses two or more agents, each distributing promotional cards to a plurality of customers.

In operation, a promoter and one or more merchants enter into a business relationship pursuant to which the promoter promotes the businesses of the merchants and is compensated by the merchants. The promoter manufactures or has manufactured a plurality of promotional cards and also obtains one or more agents to distribute the cards. Each agent receives one or more promotional cards for distribution to customers.

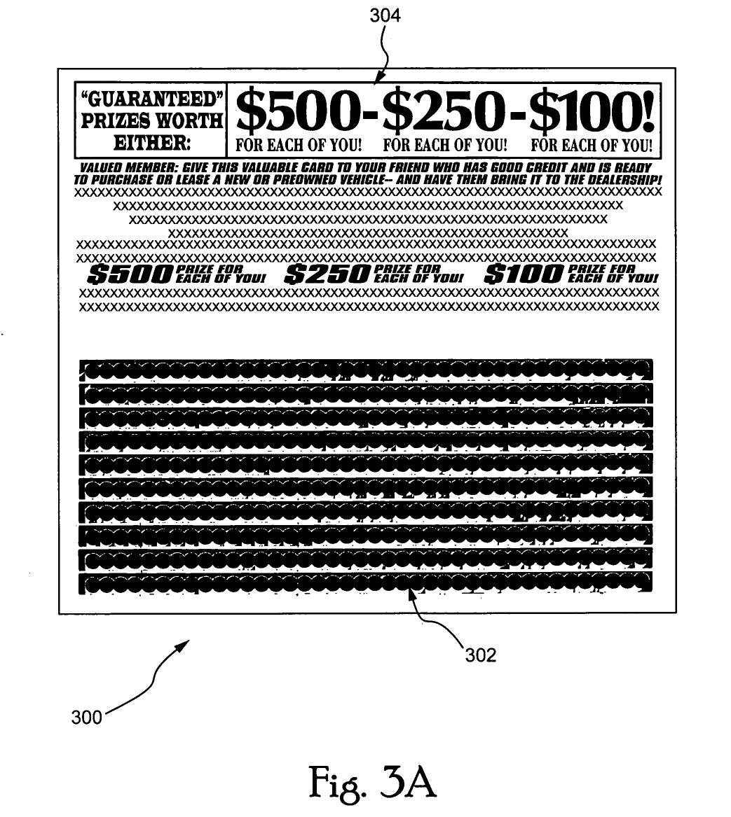

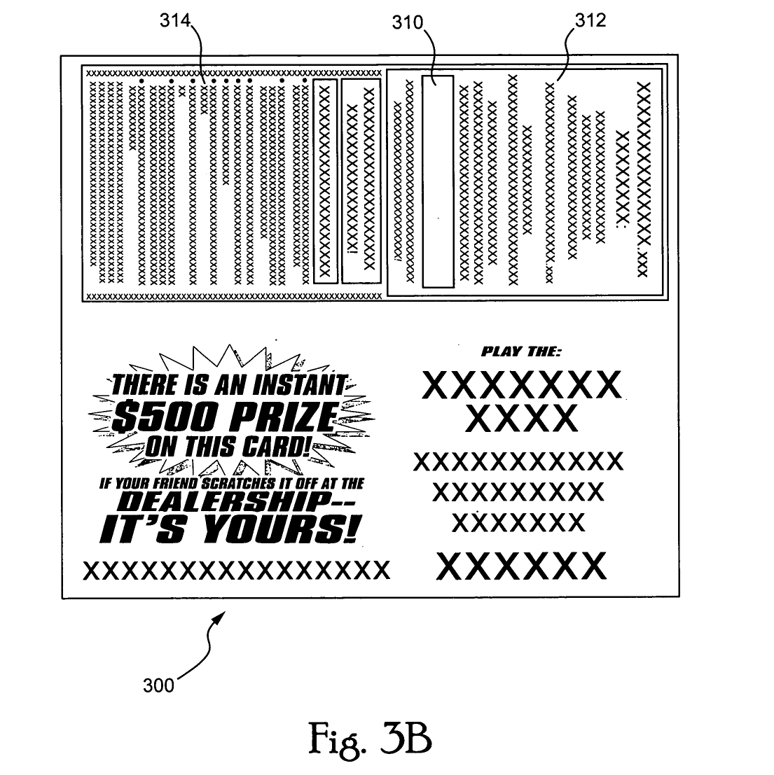

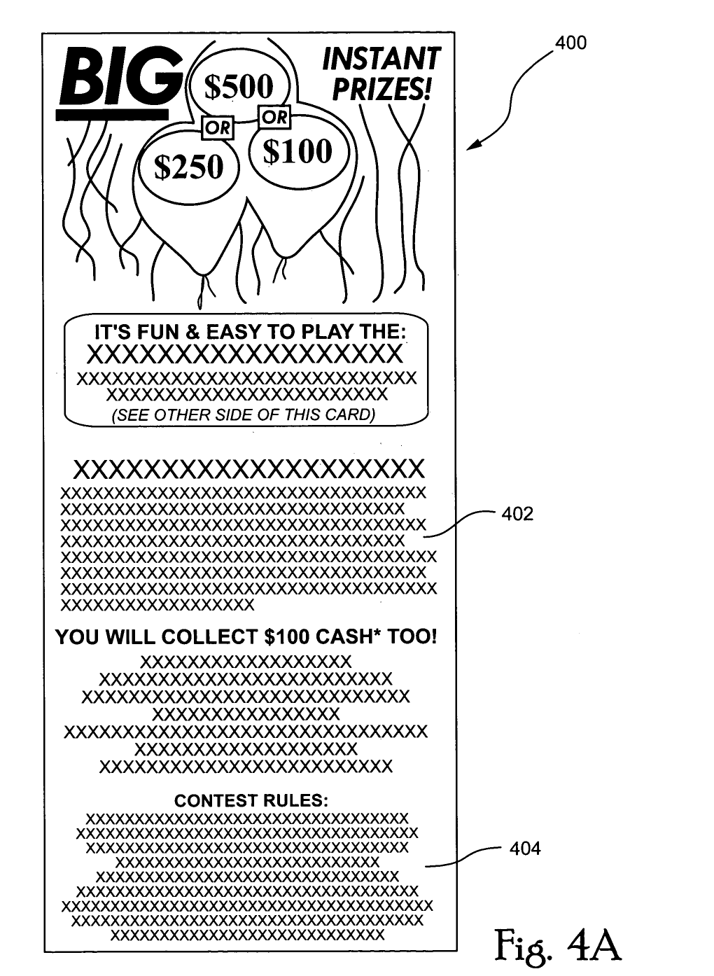

The promotional cards are imprinted, either originally, by promoter 104, or later, by agent 106, to indicate the identity of the agent. In one embodiment, each agent is given an identification number upon agreeing to be an agent. Further to this embodiment, each agent then enters his or her identification number into an agent identification field on the promotional cards. An example of a card of this type is shown in FIGS. 3A-3B.

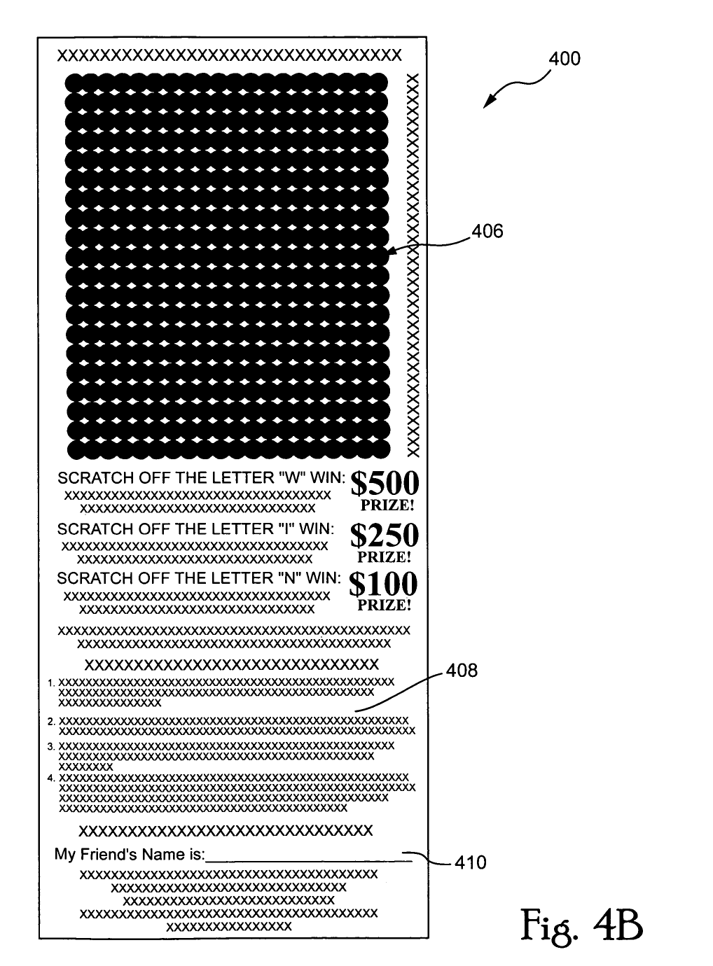

In another embodiment, the promotional cards are coded and an agent activates the cards that he or she receives by entering his or her identification data on an Internet website sponsored by the promoter. In this embodiment, each customer enters his or her name into a customer identification field on the card. An example of a card of this type is shown in FIGS. 4A-4B.

After receiving his or her promotional cards, each agent 106 distributes the promotional cards in his or her possession to potential customers 108 of one or more merchants 102. While each customer is under no obligation to do anything in response to accepting a promotional card, in one embodiment the customer understands that they will receive a benefit by presentation of the promotional card when they make use of the business of the merchant. Those customers who do make use of the business of the merchant, present their promotional cards to the merchant at the time of purchase, lease or other transaction with the merchant. At this time, the merchant verifies that the promotional card is properly redeemable, i.e., that the rules of the promotion have been satisfied, and the customer is allowed to scratch-off one of the scratch-off figures present on the card to reveal the indication of a prize. The prize indicated under the scratched-off figure is provided by the merchant to the customer. In one embodiment, the prize provided is related to the purchase or lease of products or services by the customer from the merchant, such as a discount in price.

Thereafter, the customer 108 informs the agent 106 of the redeemed card and the amount of the benefit received by the customer. The agent then provides the same information, along with the identity of the customer, to the promoter 104. The promoter then verifies the card redemption with the merchant 102 and disburses a benefit to the agent, which may or may not be based on the benefit received by the customer.

In one embodiment, there can be a plurality of merchants 102, each entering into a promotional agreement with a single promoter 104. Further to this embodiment, customers 108 can be informed of participating merchants 102 by means such as, but not limited to: advertisements on the radio, television, newspapers or other circulations, and so on; advertisements or notice by the merchants at their places of business; direct communication from the promoter by telephone, mailings, or the like; accessing an Internet website; calling or visiting the promoter; and so forth. One example of a method to determine participating merchants is described in greater detail with reference to FIGS. 3A-3B later herein.

FIG. 2A shows a front view of a promotional card 200 according to one embodiment of the invention. Promotional card 200 comprises an array 202 of scratch-off figures, a header 204, a product identifier 206, an agent identifier introduction 208, an agent identifier 210, a merchant identifier introduction 212, and one or more merchant identifiers 214. Array 202 is a ten by ten array of circular scratch-off figures, although any suitable number and suitable shape of scratch-off figures can be used. The scratch-off circles are formed from an opaque material and each covers an image or message representing a prize. In use, a customer can use a relatively stiff object adapted for scraping, such as a coin, knife or other blade-shaped object, or even a fingernail to scrape or scratch off the covering material to reveal the prize identification underneath.

Header 204, reading “Promotional Game For,” generally identifies the purpose or name of the promotional game to which promotional card 200 belongs. Product identifier 206, reading “First Product,” identifies the products or services, for which the promotional card can be used. Agent identifier introduction 208, reading “Provided By:,” alerts the customer to the identity of the providing agent. Agent identifier 210, reading “First Agent,” identifies or is the name of the agent. Merchant identifier introduction 212, reading “Participating Merchants:,” alerts the customer that identification of participating merchants follows. Merchant identifier 214, reading “First Merchant,” identifies one or more participating merchants.

In use, customer 108 redeems promotional card 200 at a participating merchant 102 at the time of purchase, lease, or entering into an agreement to purchase or lease a product or service. The customer scratches off one of the scratch-off figures in array 202 to reveal the amount of the benefit to be received. Examples of the benefits received are described in greater detail with reference to FIG. 2C later herein.

FIG. 2B shows a rear view of promotional card 200 of FIG. 2A. A set of rules 220 are shown. While not shown in detail, rules 220 of the promotional game are printed on card 200 to provide notice to participating customers for legal purposes.

FIG. 2C shows an enlarged view of a partial array 230 of scratch-off figures in array 202 of card 200 of FIG. 2A. Partial array 230, measuring four scratch-off disks by four scratch-off disks, is shown without the covering scratch-off material. This partial array includes a disk 232, a disk 234, and a disk 236. Various prize amounts are visible ranging from $100 to $500.

In use, when a customer 108 selects and scratches off the scratch-off material covering of one of the disks, the underlying printed prize amount is revealed. By way of example, disk 232 indicates a prize of $100, disk 234 indicates a prize of $500, and disk 236 indicates a prize of $250. In one embodiment, each scratch-off figure covers a prize amount so that the customer is guaranteed to win something. In other embodiments, however, the prizes indicated under the scratch-off figures can each have a different value such as, but not limited to, a non-monetary prize, no prize, a gag prize, and a monetary prize having a different range than shown.

FIG. 3A shows a front view of a promotional card 300 according to another embodiment. Shown is an array 302 of scratch-off figures and an information section 304.

Array 302 comprises 400 scratch-off figures of circular shape arrayed in a ten by forty arrangement. Information section 304 contains textual information for the benefit of customer 108. Included in information section 304 is notice that the customer can redeem the promotional card 300 as part of a purchase or lease of a vehicle, that the customer will receive an amount off the purchase or lease price as indicated by whichever scratch-off disk the customer scratches off, and that each and every scratch-off disk covers a prize amount. Notice is further given that, out of the 400 disks, one prize is $500, ten prizes are $250, and the remainder of the prizes are $100, hidden under the scratch-off disks. Information section 304 also advises the agent that he or she will receive a prize from the promoter that is equal in amount to the prize received by the customer from the merchant.

FIG. 3B shows a back view of promotional card 300 of FIG. 3A. Shown is a member I.D. entry field 310, a participating dealer information site 312, and a set of game rules 314.

Agent 106 enters his or her identification number in member entry field 310. Participating dealer information site 312 provides the customer with an Internet website for the customer to determine which dealers will honor promotional card 300. The use of an extrinsic site to convey the participating dealer information allows promoter 104 to add and drop participating dealers without rendering the promotional card obsolete, as would occur if the participating dealers were listed on the card. Game rules 314 set forth the rules for redeeming the promotional card, giving notice to the customer of what activity is necessary for successful redemption of the card.

FIG. 4A shows a front view of another embodiment of a promotional card 400 having an information section 402 and a set of game rules 404. The game embodied by card 400 is similar to the game embodied by card 300 except that in the card 300 game, the prize received by the agent is the same as that received by the customer, and in the card 400 game, the prize received by the agent is a fixed amount and independent of the amount of the prize received by the customer.

FIG. 4B shows a back view of card 400, including a 20×20 array 406 of scratch-off figures. Also provided are instructions 408 for activating the card via the Internet and a blank field 410 for entering the name of the customer. Activation of the card by the agent identifies the card and agent to the promoter.

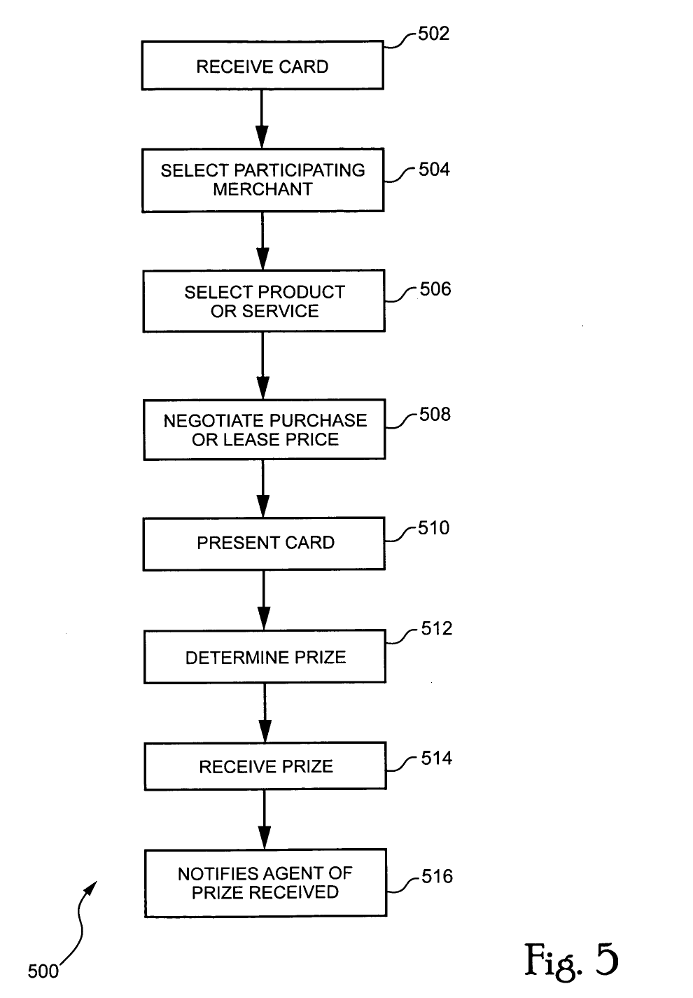

FIG. 5 shows a flowchart for a method 500 of customer 108 participation according to one embodiment of the invention. Initially, a potential customer receives 502 a promotional card 200, 300, 400 generally from an agent 106. The customer then determines 504 the participating merchants 102. If the customer locates 506 a product or service he or she wants, the customer negotiates 508 the purchase or lease price. Prior to tendering payment for the product or service, the customer presents 510 the promotional card, scratches off 512 one of the scratch-off figures, and receives 514 the amount revealed as a discount from the purchase price. The customer then notifies 516 the agent from whom he or she received the card of the card redemption and prize amount. At this point, after benefitting from the discount, the customer is normally done with his or her participation in the promotional process.

In some business fields, the act of negotiation 508 is not usually applicable. Examples include the purchase of grocery store items, most retail outlets, and so forth. Examples of business fields in which the negotiation step would normally be appropriate include, but are not limited to, automobile and truck purchasing or leasing, home audio product purchasing or leasing, and so forth.

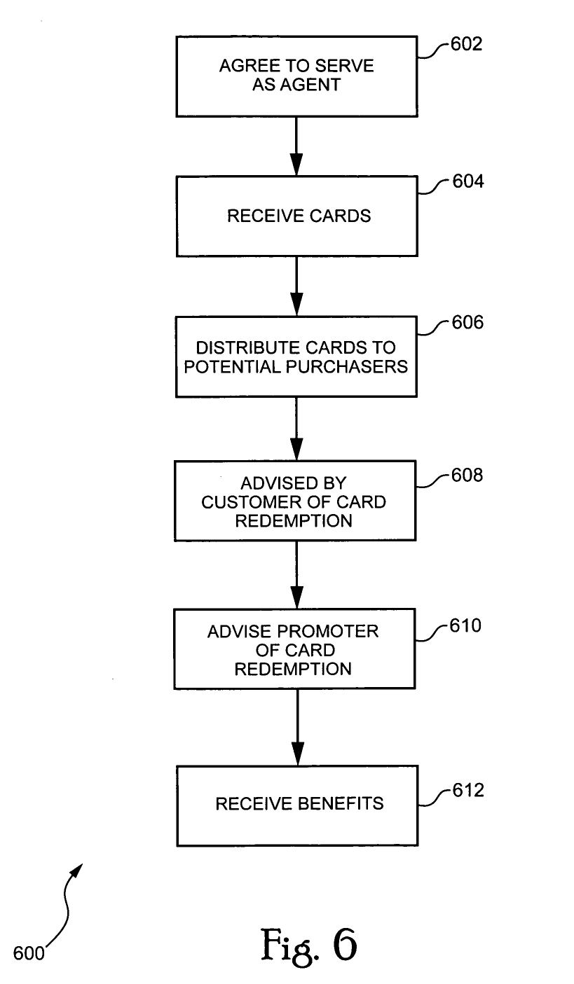

FIG. 6 shows a flowchart for a method 600 of agent 106 participation according to one embodiment of the invention. Initially, a potential agent agrees 602 to be an agent, possibly by formally signing a contract with a promoter 104. The agent receives 604 a plurality of promotional cards 200, 300, 400. The agent then selects potential customers 108 and distributes 606 the promotional cards. In one embodiment, each customer is only allowed one promotional card but other embodiments in which a given customer can receive and use two or more promotional cards are possible. After a customer redeems a card, he or she advises 608 the agent of that fact and the amount of the prize received. The agent then provides 610 the promoter with the same information and the name of the customer. The promoter, after verifying such information with the merchant 102 who honored the card, provides 612 a benefit to the agent. Generally, the agent desires to maximize the likelihood that each potential customer successfully purchases a product or service from one of the merchants, and, thus, redeems their promotional card. This is because the agent receives a benefit each time a customer redeems a promotional card.

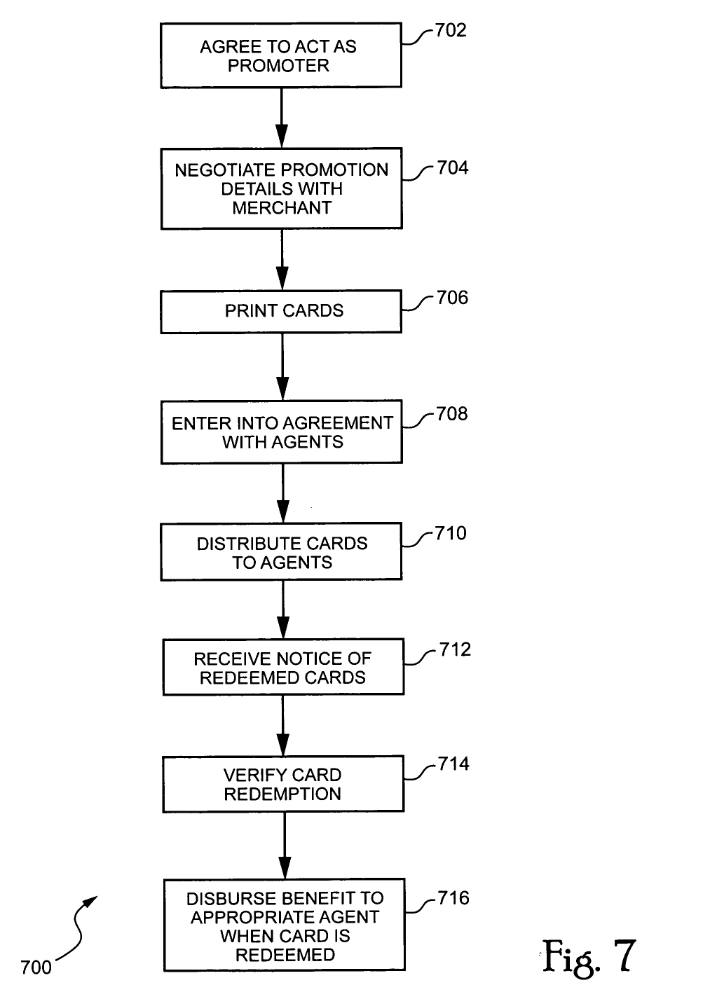

FIG. 7 shows a flowchart for a method 700 of promoter 104 participation according to one embodiment of the invention. Initially, a promoter agrees 702 to promote one or more merchants 102. Generally, this entails entering into a written contract to ensure that both sides, the promoter and the merchant, are able to enforce their rights. Generally, before entering into an agreement with the merchant, the promoter and merchant negotiate 704 the details of the promotion, including the number, amount, and nature of the prizes per promotional card 200, 300, 400, what products or services are to be involved, and so forth. Once the details of the promotion have been negotiated, the promoter causes 706 the promotional cards to be printed. The promoter then locates one or more suitable agents 106 and enters 708 into an agreement with them. The agreement between the promoter and each agent can be formal, such as a written contract, or less formal, such as an oral agreement supported by the language printed on the promotional card. After an agent has been secured, the promoter provides 710 the agent with a set of promotional cards for distribution. Once the promoter receives notice 712 from an agent that a customer 108 has redeemed one of the promotional cards, the promoter verifies 714 the redemption, including customer name and prize amount, with the merchant who honored the card. The promoter then disburses 716 an appropriate prize or benefit to the responsible agent.

As described above with reference to promotional card 300, the agent can receive a benefit equal to the benefit received by the customer. For example, if a customer redeemed a card 300 and received $300 off of the purchase price, then the agent responsible for distributing that card also receives $300 from the promoter. Alternatively, as described above with reference to promotional card 400, the agent can receive a fixed benefit irrespective of the benefit received by the customer. For example, if a customer redeemed a card 400 and received either $100, $250 or $500 off the purchase price, then the responsible agent would receive a preset, fixed amount, such as $100. In other embodiments, the benefit or prize received by the agent can be a prorated amount of the amount received by the customer, and so forth.

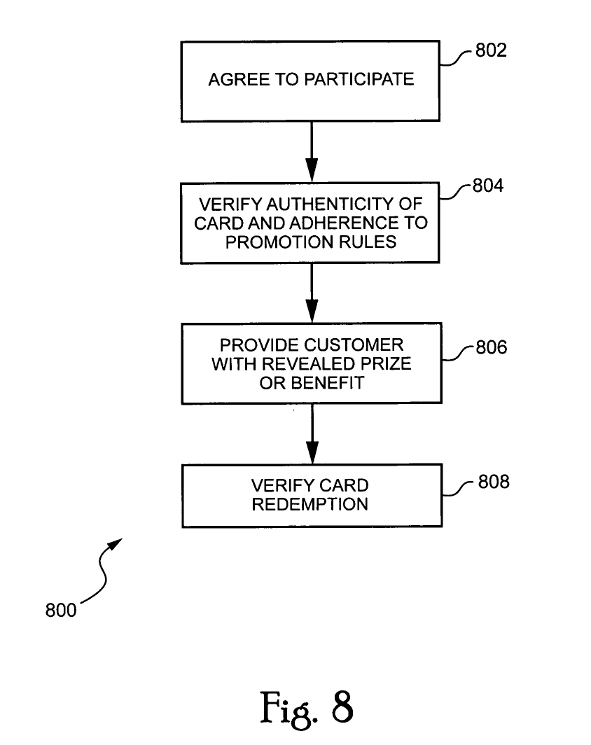

FIG. 8 shows a flowchart for a method 800 of merchant 102 participation according to one embodiment of the present invention. Initially, a merchant agrees 802 to market certain products or services via a promoter 104. As discussed with reference to FIG. 7, the merchant generally enters into a written agreement with the promoter. Once the merchant has entered into a marketing agreement, his or her next action normally is to respond to a customer 108 who has produced a promotional card 200, 300, 400 during a purchase or lease transaction. The merchant first verifies 804 that the rules of the promotion have been met by the customer and, if so, the merchant honors 806 the promotional card by allowing the customer to scratch off the material covering one prize indication to reveal a prize amount underneath. The merchant can provide the prize amount as a cash discount off the purchase or lease price agreed to by the customer. Normally, the merchant retains the promotional card for his or her records or returns it to the promoter. In addition to providing the prize to the customer, the merchant, upon request of the promoter, provides 808 the promoter with the name of the customer who redeemed the card and the amount of the prize received so that the promoter is able to fulfill his or her obligation to provide a companion prize to the responsible agent, as discussed with reference to FIGS. 6-7 previously herein.

The foregoing detailed description is illustrative of different embodiments of the invention, and it is to be understood that additional embodiments thereof will be obvious to those skilled in the art. The embodiments described herein together with those additional embodiments are considered to be within the scope of the invention as defined by the following claims.

I claim:

1. A method for promoting a business offering, including the use of a promotional card containing a plurality of scratch-off figures made from an opaque material, each said figure covering an indication of one of the group consisting of: a prize and no prize, said method comprising:
manufacturing said promotional card;
distributing, by a promoter, said promotional card to at least one agent;
distributing, by said agent, said promotional card to at lease one potential customer;
receiving, by a merchant, said promotional card from a customer;
observing, by said merchant, the removal, by said customer, of the scratch-off material covering one of said indications on said promotional card, thereby revealing an indication of a prize or no prize;
if said indication is of a prize, providing, by said merchant, said customer with said prize when said customer purchases or leases said business offering; and
providing, by said promoter, said agent with a benefit.

2. A method of promoting a business offering as recited in claim 1, wherein the benefit provided by said promoter to said agent is of a preset, fixed value independent of any prize provided to said customer by said merchant.

3. A method for promoting a business offering as recited in claim 1, wherein each of said indications is of a prize.

4. A method for promoting a business offering as recited in claim 3, wherein the value of the benefit provided to said agent by said promoter is related to the value of the prize provided to said customer by said merchant.

5. A method for promoting a business offering, said method comprising:
agreeing with a merchant to promote said business offering;
determining one or more prizes and a corresponding target winning chance for each said prize;
manufacturing a promotional game card, said promotional game card containing a plurality of scratch-off figures, each said figure covering an indication of one of the group consisting of: a prize and no prize;
providing said promotional card to an agent for distribution to a potential customer;
receiving notification that said promotional card has been redeemed by a customer of said merchant; and
providing said agent with a benefit.

6. A method of promoting a business offering as recited in claim 5, wherein the benefit provided to said agent is of a preset, fixed value independent of any prize provided to said customer.

7. A method for promoting a business offering as recited in claim 5, wherein each of said indications is of a prize.

8. A method for promoting a business offering as recited in claim 7, wherein the value of the benefit provided to said agent is related to the value of the prize provided to said customer.
